(19) United States
(12) Patent Application Publication
(10) Pub. No.: US 2019/0182331 A1
(43) Pub. Date: Jun. 13, 2019

(54) Head Unit of Vehicle and Method for Controlling the Same

(71) Applicants: Hyundai Motor Company, Seoul (KR); Kia Motors Corporation, Seoul (KR)

(72) Inventors: Hyewon You, Seoul (KR); Minhyuk Oh, Seoul (KR); Keunhang Heo, Yongin-si (KR)

(21) Appl. No.: 15/963,674

(22) Filed: Apr. 26, 2018

(30) Foreign Application Priority Data
Dec. 12, 2017 (KR) 10-2017-0169971

(51) Int. Cl. H04L 29/08; B60K 35/00; H04W 76/14

(52) U.S. Cl. CPC H04L 67/125; H04W 84/18; H04W 76/14; B60K 35/00

(57) ABSTRACT

A head unit and a method for controlling the same are disclosed, which output the audio streams generated from a plurality of devices connected to a single head unit through Bluetooth communication. The head unit of a vehicle includes a Bluetooth communicator and a controller. The Bluetooth communicator is configured to be communicably connected to a plurality of Bluetooth devices. The controller is configured to allocate priority information based on a preset reference to the respective Bluetooth devices, and control an audio route of each of the plurality of Bluetooth devices according to the priority information so as to output all audio streams generated by the plurality of Bluetooth devices.

### CROSS-REFERENCE TO RELATED APPLICATIONS

This application claims priority to Korean Patent Application No. 10-2017-0169971, filed in the Korean Intellectual Property Office on Dec. 12, 2017, which application is hereby incorporated herein by reference.

### TECHNICAL FIELD

Embodiments of the present disclosure relate to a head unit of a vehicle a method for controlling the head unit.

### BACKGROUND

The technical scope of devices, known as smartphones, capable of being connected to the latest mobile devices has been rapidly extended from conventional simple input devices (keyboard, mouse, speaker, etc.) to various kinds of products. In vehicle technology, a mobile device of a user is connected to a head unit of the vehicle, such that various functions of the mobile device can also be easily used in the head unit of the vehicle.

Communication connection between the head unit and the mobile device may be wireless communication such as Wi-Fi or Bluetooth. In wireless communication, various control or data transmission can be implemented through wireless access.

However, some Bluetooth versions may not support simultaneous output of audio streaming generated from a plurality of mobile devices connected to a single head unit. Therefore, although message reception or call connection is achieved during listening to music, related alarm sounds or the like may not be output.

### SUMMARY

Embodiments of the present disclosure relate to a vehicle. Particular embodiments relate to a method for controlling Bluetooth communication between a head unit of the vehicle and a mobile device of a user.

It is an aspect of the present disclosure to provide a technology for outputting the audio streams generated from a plurality of devices connected to a single head unit through Bluetooth communication.

Additional aspects of the invention will be set forth in part in the description which follows and, in part, will be obvious from the description, or may be learned by practice of the invention.

In accordance with an aspect of the present disclosure, a head unit of a vehicle includes a Bluetooth communicator configured to be communicably connected to a plurality of Bluetooth devices. A controller is configured to allocate priority information based on a preset reference to the respective Bluetooth devices, and to control an audio route of each of the plurality of Bluetooth devices according to the priority information so as to output all audio streams generated by the plurality of Bluetooth devices.

The controller may control the audio route in a manner that the audio stream of a Bluetooth device having high priority is output through the head unit and control the audio route in a manner that audio stream of a Bluetooth device having low priority is output through the low-priority Bluetooth device.

The controller may allocate higher priority to the Bluetooth device capable of generating an audio stream at a relatively earlier time.

The controller may allocate higher priority to the Bluetooth device connected through a call-associated profile. The call-associated profile may be a hands-free profile.

When any one of the plurality of audio streams is output through audio ducking during overlapping of the plurality of audio streams generated by the plurality of Bluetooth devices, the controller may perform muting of the other audio stream.

During the audio ducking, the controller may control a volume of system/message alarm sound to remain unchanged, and may perform muting of other audio streams.

When the plurality of Bluetooth devices are interconnected through a call-associated profile, the controller may allocate higher priority to the Bluetooth device staying in a call connection state through the call-associated profile.

The call-associated profile may be a hands-free profile.

In accordance with another aspect of the present disclosure, a method for controlling a head unit of a vehicle includes allocating priority information based on a preset reference to a plurality of Bluetooth devices interconnected to communicate with each other. Audio routes of the respective Bluetooth devices are controlled according to the priority information so as to output all audio streams generated by the plurality of Bluetooth devices.

Controlling the audio routes may include controlling the audio routes in a manner that an audio stream of a Bluetooth device having high priority information is output through the head unit, and controlling the audio routes in a manner that an audio stream of a Bluetooth having low priority information is output through the low-priority Bluetooth device.

The method may further include allocating higher priority to the Bluetooth device capable of generating an audio stream at a relatively earlier time.

The method may further include allocating higher priority to the Bluetooth device connected through a call-associated profile. The call-associated profile may be a hands-free profile.

The method may further include muting the other audio stream when any one of the plurality of audio streams is output through audio ducking during overlapping of the plurality of audio streams generated by the plurality of Bluetooth devices.

The method may further include, during the audio ducking, controlling a volume of system/message alarm sound to remain unchanged, and muting other audio streams.

The method may further include, when the plurality of Bluetooth devices are interconnected through a call-associated profile, allocating higher priority to the Bluetooth device staying in a call connection state through the call-associated profile.

The call-associated profile may be a hands-free profile.

In accordance with another aspect of the present disclosure, a head unit of a vehicle includes a Bluetooth communicator configured to be communicably connected to a plurality of Bluetooth devices. A controller is configured to allocate priority information based on a preset reference to the respective Bluetooth devices, to control an audio route in a manner that an audio stream of the Bluetooth device having high priority information is output through the head unit, and to control an audio route in a manner that an audio stream of the Bluetooth having low priority information is output through the Bluetooth device, thereby outputting all audio streams generated by the plurality of Bluetooth devices.

In accordance with another aspect of the present disclosure, a method for controlling a head unit of a vehicle includes allocating priority information based on a preset reference to a plurality of Bluetooth devices interconnected to communicate with each other An audio route is controlled in a manner that an audio stream of the Bluetooth device having high priority information is output through the head unit and an audio stream of the Bluetooth having low priority information is output through the Bluetooth device. All audio streams generated by the plurality of Bluetooth devices are output.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a view illustrating connection between a head unit of a vehicle and a plurality of mobile devices according to an embodiment of the present disclosure.

FIG. 2 is a block diagram illustrating a control system of the head unit of the vehicle according to an embodiment of the present disclosure.

FIG. 3 is a flowchart illustrating a method for controlling the head unit of the vehicle according to an embodiment of the present disclosure.

FIG. 4 is a flowchart illustrating a method for controlling the head unit according to a first embodiment of the present disclosure.

FIG. 5 is a flowchart illustrating a method for controlling the head unit according to a second embodiment of the present disclosure.

FIG. 6 is a flowchart illustrating a method for controlling the head unit according to a third embodiment of the present disclosure.

FIG. 7 is a flowchart illustrating a method for controlling the head unit according to a fourth embodiment of the present disclosure.

FIG. 8 is a flowchart illustrating a method for controlling the head unit according to a fifth embodiment of the present disclosure.

### DETAILED DESCRIPTION OF ILLUSTRATIVE EMBODIMENTS

Reference will now be made in detail to the embodiments of the present disclosure, examples of which are illustrated in the accompanying drawings, wherein like reference numerals refer to like elements throughout.

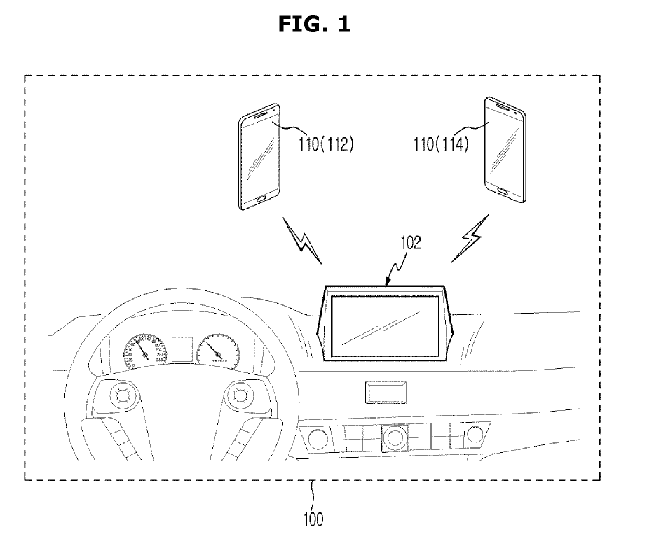

FIG. 1 is a view illustrating connection between a head unit of a vehicle and a plurality of mobile devices according to an embodiment of the present disclosure.

Referring to FIG. 1, a head unit 102 embedded in the vehicle 100 is an audio/video/navigation (AVN) device or a multimedia device, and may perform various functions such as audio/video/navigation/telematics functions. The head unit 102 may be connected to a plurality of Bluetooth devices (e.g., a plurality of mobile devices 112 and 114) such that the Bluetooth devices 112 and 114 can communicate with each other through Bluetooth communication.

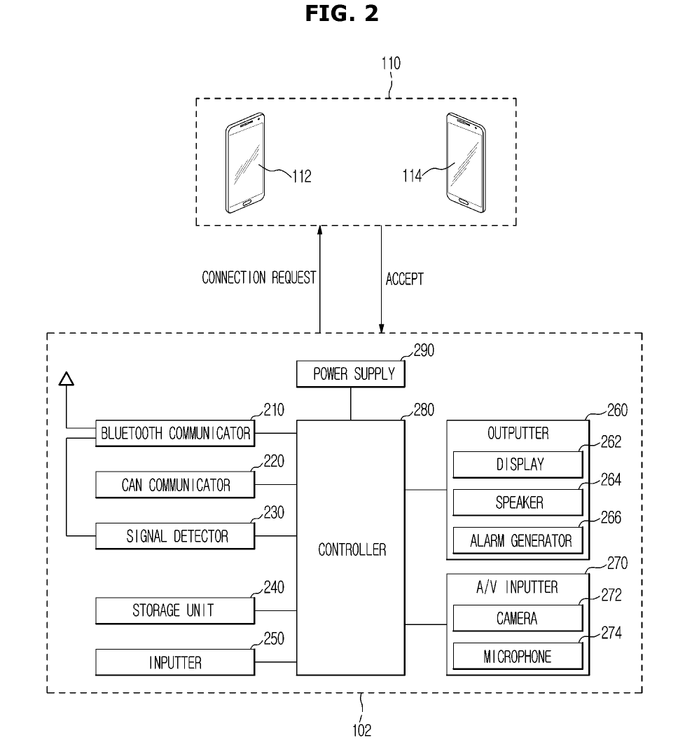

Bluetooth communication may be a version for supporting an Advanced Audio Distribution Profile (A2DP) and a Hands Free Profile (HFP). The head unit 102 may output an audio signal that is transmitted from the mobile devices 112 and 114 interconnected through Bluetooth communication to the head unit 102, to the speaker 264 (see FIG. 2) connected to the head unit 102. In general Bluetooth communication refers to any communication compliant with a Bluetooth standard in effect as of the filing of this patent application.

FIG. 2 is a block diagram illustrating a control system of the head unit of the vehicle according to an embodiment of the present disclosure.

Referring to FIG. 2, the head unit 102 of the vehicle 100 according to the embodiment of the present disclosure may include a Bluetooth communicator 210, a Controller Area Network (CAN) communicator 220, a signal detector 230, a storage unit 240, an input circuit 250, an output circuit 260, an Audio/Video (A/V) inputter 270, a controller 280, and a power supply 290.

The Bluetooth communicator 210 may include an antenna configured to receive a Bluetooth signal, and a signal processing module configured to perform processing of signals for the Bluetooth signal received through the antenna.

The CAN communicator 220 may communicate with a plurality of Electronic Control Units (ECUs) embedded in the vehicle 100. For example, when the vehicle 100 is turned on, the CAN communicator 220 may receive a control signal for indicating the ‘ACC ON’ state from the ECU configured to detect the engine ignition of the vehicle 100, and may transmit the received control signal to the controller 280. The controller 280 may output power to the head unit 102 in response to the control signal, and may perform automatic pairing with the head unit 102 and the plurality of mobile devices 110.

The signal detector 230 may correspond to a Received Signal Strength Indicator (RSSI), and may measure strength of a signal received from the mobile device 110. The signal detector 230 may identify a pairing available mobile device 110 based on strength of the detected signal, and may inform the controller 280 of the identified pairing available mobile device 110.

The storage unit 240 may store program data for operating the controller 280 and other constituent elements controlled by the controller 280, and may temporarily store input/output (I/O) data therein. The program data stored in the storage unit 240 may include application programs for Bluetooth communication, navigation, games, chatting, web surfing, schedule management, multimedia playback, etc. Data temporarily stored in the storage unit 240 may include phonebook information, list of calls, messages, still images, moving images, application programs, etc.

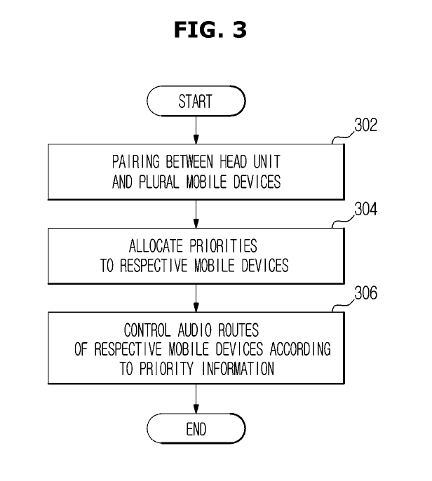

The storage unit 240 may store priority information per pre-allocated Bluetooth profile. A method for allocating priority per Bluetooth profile and a method for controlling the Bluetooth device according to the allocated priority will hereinafter be described with reference to FIGS. 3 to 8. The input circuit 250 may be a user interface (UI) for controlling the operation of the head unit 102.

The output circuit 260 may be provided to output signals associated with visible, auditory, and tactile sensations. The output circuit 260 may include a display 262, a speaker 264, an alarm generator 266, etc.

The display 262 may visually display information processed by the head unit 102. For example, when the head unit 102 is in a call mode, the controller 280 may display a user interface (UI) associated with the call on the display 262. When the head unit 102 is in a navigation mode, the controller 280 may display a user interface (UI) associated with navigation on the display 262. When the display 262 is in a pairing mode, the controller 280 may construct pairing progress state information and a pairing associated menu using a user interface (UI), and may thus display the resultant UI on the display 262.

The speaker 264 may output audio signals generated in the call mode, a record mode, a voice recognition mode, a Bluetooth pairing mode, etc.

The speaker 264 may output audio signals (e.g., a ringback tone, a dial tone, a system/message alarm sound, etc.) associated with a function executed in the head unit 102.

The alarm generator 266 may output a notification signal of event occurrence of the head unit 102. For example, the event generated in the head unit 102 may include call reception, message reception, key signal input, touch input, and state information reception. The state information may include vehicle 100's door opening information, engine overheating information, lane departure information, fuel state information, etc. received from the CAN communicator 220. The alarm generator 266 may also output other signals (for example, a signal for indicating event occurrence using vibration) other than a video or audio signal. The video or audio signal may also be output through the display 262 or the speaker 264.

The A/V inputter 270 may generate input (or generation) of the audio or video signal, and may include a camera 272, a microphone 274, etc.

The power supply 290 may provide power needed to operate the head unit 102. When the vehicle 100 is turned on, the power supply 290 may automatically supply power to the head unit 102. Of course, when the vehicle 100 is turned off, the power supply 290 may automatically stop supplying power to the head unit 102.

The controller 280 may control overall operations of the head unit 102. For example, the controller 280 may control Bluetooth pairing based communication functions (i.e., a voice call, data communication, a video call, phonebook download, etc.) but also installation and driving of the application program. Specifically, the controller 280 may select a service to be executed earlier than the preset priority per Bluetooth profile, and may select the selected service. In addition, when a plurality of profiles is simultaneously executed, the controller 280 may dynamically decide CPU resources to be distributed to the respective profiles. When the Bluetooth profile is added or deleted, the controller 280 may dynamically redistribute CPU resources of the respective profiles.

When it is impossible for resources to be simultaneously occupied by the plurality of Bluetooth profiles, the controller 280 may select a profile scheduled to occupy the corresponding resource on the basis of the preset priority per profile, and may control the corresponding resource to be occupied by the selected profile. For example, when an incoming call occurs while playing music in the background, the controller 280 may stop playing the music and may connect the incoming call. That is, the controller 280 may control a speaker resource to be occupied by the hands-free profile.

FIG. 3 is a flowchart illustrating a method for controlling the head unit of the vehicle according to an embodiment of the present disclosure.

Referring to FIG. 3, the AVN device 102 may communicate with the plurality of mobile devices 112 and 114 through Bluetooth pairing (302). The controller 280 may allocate different priorities based on a preset reference to the plurality of mobile devices 112 and 114 interconnected to communicate with each other (304). The controller 280 may control audio paths of the mobile devices 112 and 114 according to priority information in a manner that all audio streams generated from the mobile devices 112 and 114 can be output (306).

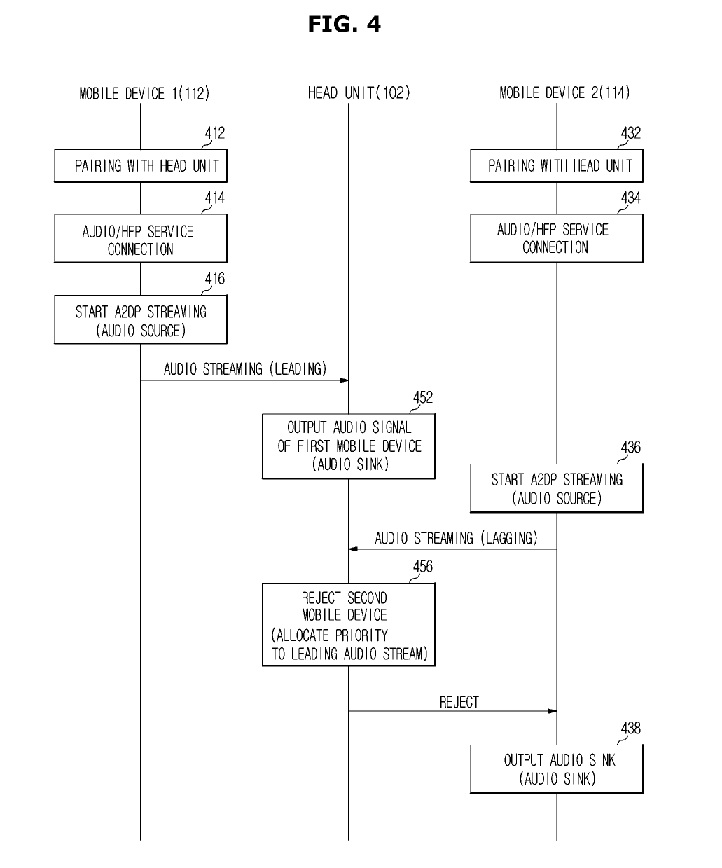

FIG. 4 is a flowchart illustrating a method for controlling the head unit according to a first embodiment of the present disclosure.

Referring to FIG. 4, the first mobile device (Mobile Device 1) 112 acting as a Bluetooth device may be communicably connected to the head unit 102 through Bluetooth pairing (412). Bluetooth pairing between the first mobile device 112 and the head unit 102 may require user input for authentication. Only one Bluetooth pairing between the first mobile device 112 and the head unit 102 may be considered sufficient or satisfactory. During post-pairing connection, the authentication process may be omitted, and Bluetooth connection between the first mobile device 112 and the head unit 102 may be automatically achieved.

Upon completion of Bluetooth pairing (or Bluetooth connection) between the first mobile device 112 and the head unit 102, audio/HFP (Hands-Free Profile) service connection between the first mobile device 112 and the head unit 102 may be achieved (414). The term HFP is an abbreviation of Hands-Free Profile. Due to the audio/HFP service connection, the audio stream generated by the audio function and the HFP function of the first mobile device 112 may be transmitted to the head unit 102.

In Bluetooth Low Energy (BLE) (especially versions later than 4.x), multi-connection based on Bluetooth may be supported. Other Bluetooth devices other than the first mobile device 112 may be paired with (or connected to) the head unit 102.

That is, the second mobile device (Mobile Device 2) 114 acting as the other Bluetooth device may be communicably connected to the head unit 102 through Bluetooth pairing (432). Bluetooth pairing between the second mobile device 114 and the head unit 102 may require user input for authentication. Only one Bluetooth pairing between the second mobile device 114 and the head unit 102 may be considered sufficient or satisfactory. During post-pairing connection, the authentication process may be omitted, and Bluetooth connection between the second mobile device 114 and the head unit 102 may be automatically achieved.

Upon completion of Bluetooth pairing (or Bluetooth connection) between the second mobile device 114 and the head unit 102, audio/HFP service connection between the second mobile device 114 and the head unit 102 may be achieved (434). The term HFP is an abbreviation of Hands-Free Profile. Due to the audio/HFP service connection, the audio stream generated by the audio function and the HFP function of the second mobile device 114 may be transmitted to the head unit 102.

From among the mobile devices 112 and 114 connected to the head unit 102, the first mobile device 112 may first generate the audio signal through A2DP streaming (416). That is, the first mobile device 112 may operate as the audio source for generating the audio signal. For reference, when the Bluetooth device outputs the audio signal through the speaker or audio terminal, the corresponding Bluetooth device is called an audio sink.

The head unit 102 may receive an audio stream generated through A2DP streaming in the first mobile device 112 operating as the audio source, and may output the received audio stream through the speaker 264 (452). The head unit 102 may be an audio sink capable of outputting the audio signal.

While the audio stream of the first mobile device 112 is output to the speaker 264 through the head unit 102, the second mobile device 114 corresponding to the other Bluetooth device connected to the head unit 102 may also generate the audio signal through A2DP streaming (436). In this case, the second mobile device 114 may also be the audio source for generating the audio signal through A2DP streaming in the same manner as in the first mobile device 112.

Due to technical limitations of BLE (especially versions later than 4.x), it is impossible to simultaneously output the audio signals generated from two audio sources. That is, whereas the head unit 102 may output only the audio signal generated from only one audio source through the speaker 264, the head unit 102 is unable to output other audio signals generated from the remaining audio sources through the speaker 264.

Therefore, the head unit 102 according to the embodiment of the present disclosure may select any one of the highest-priority audio sources from among a plurality of audio sources being multi-connected through Bluetooth communication, and may control an audio route in a manner that the audio signal of the corresponding audio source can be output through the speaker 264. The head unit 102 may reject audio signals of the remaining low-priority audio sources so as to prevent the audio signals from being output through the speaker 264, and may control the audio route in a manner that the corresponding audio to be used as an audio sink can autonomously output the audio signals.

In FIG. 4, the head unit 102 may allocate the highest priority to the first mobile device 112 having started audio streaming at a relatively earlier time. Therefore, the head unit 102 may output the audio signal of the first mobile device 112 having the highest priority to the speaker 264. In addition, the head unit 102 may reject an audio streaming request of the second mobile device 114 having relatively low priority due to later audio streaming, and may control the audio route in a manner that the audio signal can be autonomously generated through the speaker or audio terminal of the second mobile device 114 (456).

By the above-mentioned rejection and audio route control (456) of the head unit 102, the second mobile device 114 may be shifted from the audio source to the audio sink, and the audio signal generated from the second mobile device 114 may be autonomously output through the second mobile device 114 (438).

By the above-mentioned audio route control of the head unit 102, it can be recognized that the audio streams of all Bluetooth devices multi-connected to the head unit 102 can be output without omission.

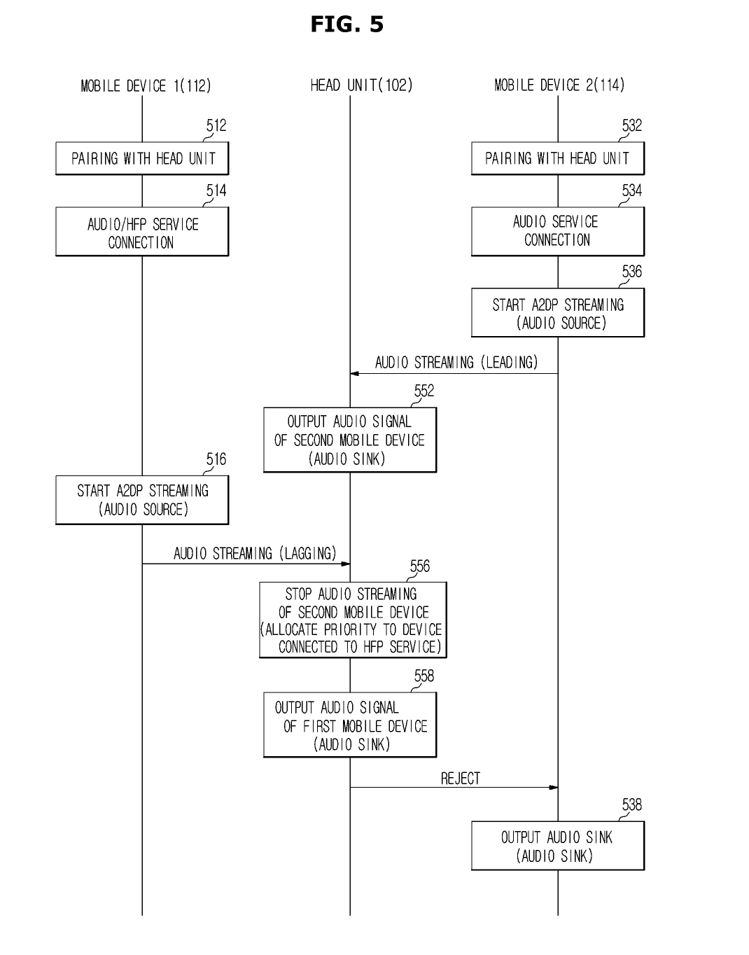

FIG. 5 is a flowchart illustrating a method for controlling the head unit according to a second embodiment of the present disclosure.

Referring to FIG. 5, the first mobile device (Mobile Device 1) 112 acting as a Bluetooth device may be communicably connected to the head unit 102 through Bluetooth pairing (512). Bluetooth pairing between the first mobile device 112 and the head unit 102 may require user input for authentication. Only one Bluetooth pairing between the first mobile device 112 and the head unit 102 may be considered sufficient or satisfactory. During post-pairing connection, the authentication process may be omitted, and Bluetooth connection between the first mobile device 112 and the head unit 102 may be automatically achieved.

Upon completion of Bluetooth pairing (or Bluetooth connection) between the first mobile device 112 and the head unit 102, audio/HFP (Hands-Free Profile) service connection between the first mobile device 112 and the head unit 102 may be achieved (514). The term HFP is an abbreviation of Hands-Free Profile. Due to the audio/HFP service connection, the audio stream generated by the audio function and the HFP function of the first mobile device 112 may be transmitted to the head unit 102.

In Bluetooth Low Energy (BLE) (especially versions later than 4.x), multi-connection based on Bluetooth may be supported. Other Bluetooth devices other than the first mobile device 112 may be paired with (or connected to) the head unit 102.

That is, the second mobile device 114 acting as the other Bluetooth device may be communicably connected to the head unit 102 through Bluetooth pairing (432). Bluetooth pairing between the second mobile device 114 and the head unit 102 may require user input for authentication. Only one Bluetooth pairing between the second mobile device 114 and the head unit 102 may be considered sufficient or satisfactory. During post-pairing connection, the authentication process may be omitted, and Bluetooth connection between the second mobile device 114 and the head unit 102 may be automatically achieved.

Upon completion of Bluetooth pairing (or Bluetooth connection) between the second mobile device 114 and the head unit 102, audio/HFP service connection between the second mobile device 114 and the head unit 102 may be achieved (534). Due to the audio/HFP service connection, the audio stream generated by the audio function and the HFP function of the second mobile device 114 may be transmitted to the head unit 102. In the embodiment of FIG. 5, the HFP service of the second mobile device 114 is not connected, such that the head unit 102 may not support the hands-free function of the second mobile device 114.

From among the mobile devices 112 and 114 connected to the head unit 102, the first mobile device 112 may first generate the audio signal through A2DP streaming (536). That is, the first mobile device 112 may operate as the audio source for generating the audio signal. For reference, when the Bluetooth device outputs the audio signal through the speaker or audio terminal, the corresponding Bluetooth device is called an audio sink.

The head unit 102 may receive an audio stream generated through the A2DP streaming in the second mobile device 114 operating as the audio source, and may output the received audio stream through the speaker 264 (552). The head unit 102 may be an audio sink capable of outputting the audio signal.

While the audio stream of the second mobile device 114 is output to the speaker 264 through the head unit 102, the first mobile device 112 corresponding to the other Bluetooth device connected to the head unit 102 may also generate the audio signal through A2DP streaming (516). In this case, the first mobile device 112 may also be the audio source for generating the audio signal through A2DP streaming in the same manner as in the second mobile device 114.

Due to technical limitations of BLE (especially versions later than 4.x), it is impossible to simultaneously output the audio signals generated from two audio sources. That is, whereas the head unit 102 may output only the audio signal generated from only one audio source through the speaker 264, the head unit 102 is unable to output other audio signals generated from the remaining audio sources through the speaker 264.

Therefore, the head unit 102 according to the embodiment of the present disclosure may select any one of the highest-priority audio sources from among a plurality of audio sources being multi-connected through Bluetooth communication, and may control an audio route in a manner that the audio signal of the corresponding audio source can be output through the speaker 264. The head unit 102 may prevent audio signals of the remaining low-priority audio sources from being output through the speaker 264, and may control the audio route in a manner that the corresponding audio to be used as an audio sink can autonomously output the audio signals.

In FIG. 5, the head unit 102 may allocate the highest priority to the first mobile device 112 connected through the HFP service. Therefore, the head unit 102 outputting the audio signal of the second mobile device 114 may stop audio stream of the second mobile device 114, and may answer an audio streaming request of the first highest-priority mobile device 112 through HFP service connection (556).

For this purpose, on the condition that the first highest-priority mobile device 112 generates the audio signal through audio streaming, the head unit 102 may control the audio route in a manner that the audio signal of the first mobile device 112 is output through the speaker 264 (558). In this case, the head unit 102 may be an audio sink for outputting the audio signal.

By audio route control of the head unit 102, the audio stream of the second mobile device 114 is no longer output through the head unit 102 and the speaker 264. By such audio route control of the head unit 102, the second mobile device 114 may be shifted from the audio source to the audio sink, and the audio signal generated from the second mobile device 114 may be autonomously output through the second mobile device 114 (538).

By the above-mentioned audio route control of the head unit 102, it can be recognized that the audio streams of all Bluetooth devices multi-connected to the head unit 102 can be output without omission.

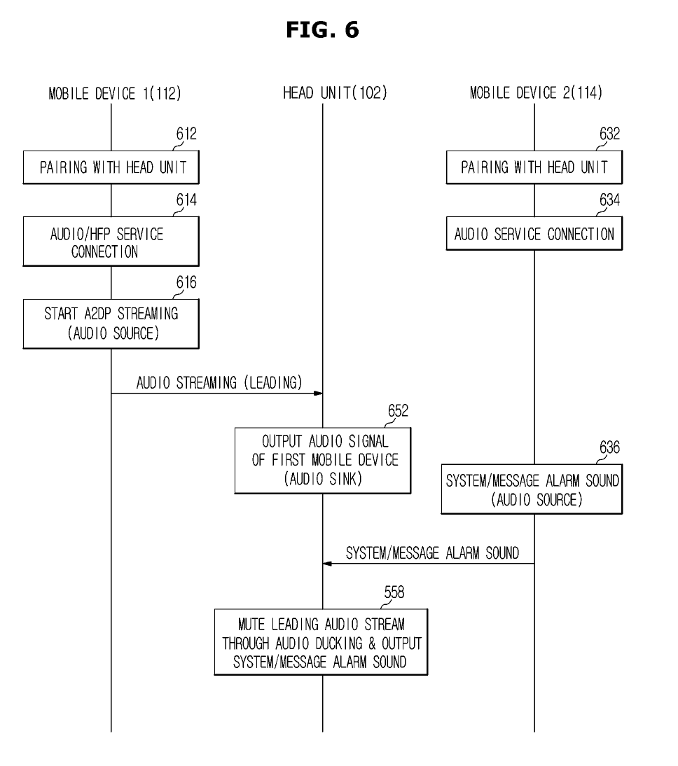

FIG. 6 is a flowchart illustrating a method for controlling the head unit according to a third embodiment of the present disclosure.

Referring to FIG. 6, the first mobile device (Mobile Device 1) 112 acting as a Bluetooth device may be communicably connected to the head unit 102 through Bluetooth pairing (612). Bluetooth pairing between the first mobile device 112 and the head unit 102 may require user input for authentication. Only one Bluetooth pairing between the first mobile device 112 and the head unit 102 may be considered sufficient or satisfactory. During post-pairing connection, the authentication process may be omitted, and Bluetooth connection between the first mobile device 112 and the head unit 102 may be automatically achieved.

Upon completion of Bluetooth pairing (or Bluetooth connection) between the first mobile device 112 and the head unit 102, audio/HFP (Hands-Free Profile) service connection between the first mobile device 112 and the head unit 102 may be achieved (614). The term HFP is an abbreviation of Hands-Free Profile. Due to the audio/HFP service connection, the audio stream generated by the audio function and the HFP function of the first mobile device 112 may be transmitted to the head unit 102.

In Bluetooth Low Energy (BLE) (especially versions later than 4.x), multi-connection based on Bluetooth may be supported. Other Bluetooth devices other than the first mobile device 112 may be paired with (or connected to) the head unit 102.

That is, the second mobile device 114 acting as the other Bluetooth device may be communicably connected to the head unit 102 through Bluetooth pairing (632). Bluetooth pairing between the second mobile device 114 and the head unit 102 may require user input for authentication. Only one Bluetooth pairing between the second mobile device 114 and the head unit 102 may be considered sufficient or satisfactory. During post-pairing connection, the authentication process may be omitted, and Bluetooth connection between the second mobile device 114 and the head unit 102 may be automatically achieved.

Upon completion of Bluetooth pairing (or Bluetooth connection) between the second mobile device 114 and the head unit 102, audio/HFP service connection between the second mobile device 114 and the head unit 102 may be achieved (634). Due to the audio/HFP service connection, the audio stream generated by the audio function and the HFP function of the second mobile device 114 may be transmitted to the head unit 102.

From among the mobile devices 112 and 114 connected to the head unit 102, the first mobile device 112 may first generate the audio signal through A2DP streaming (616). That is, the first mobile device 112 may operate as the audio source for generating the audio signal. For reference, when the Bluetooth device outputs the audio signal through the speaker or audio terminal, the corresponding Bluetooth device is called an audio sink.

The head unit 102 may receive an audio stream generated through the A2DP streaming in the second mobile device 114 operating as the audio source, and may output the received audio stream through the speaker 264 (652). The head unit 102 may be an audio sink capable of outputting the audio signal.

While the audio stream of the first mobile device 112 is output to the speaker 264 through the head unit 102, the second mobile device 114 corresponding to the other Bluetooth device connected to the head unit 102 may generate the audio stream based on the system/message alarm sound (636). In this case, the second mobile device 114 may be the audio source for generating the audio signal in the same manner as in the first mobile device 112. The system notification sound may include a disaster alarm sound or a low-battery alarm sound, etc. The message alarm sound may include a message (including a messenger) reception alarm sound, etc.

Due to technical limitations of BLE (especially versions later than 4.x), it is impossible to simultaneously output the audio signals generated from two audio sources. That is, whereas the head unit 102 may output only the audio signal generated from only one audio source through the speaker 264, the head unit 102 is unable to output other audio signals generated from the remaining audio sources through the speaker 264.

Therefore, the head unit 102 according to the embodiment of the present disclosure may select any one of the highest-priority audio sources from among a plurality of audio sources being multi-connected through Bluetooth communication, and may control an audio route in a manner that the audio signal of the corresponding audio source can be output through the speaker 264. The head unit 102 may prevent audio signals of the remaining low-priority audio sources from being output through the speaker 264, and may control the audio route in a manner that the corresponding audio to be used as an audio sink can autonomously output the audio signals.

However, when it is difficult to allocate priority information to the plurality of audio sources, the audio signals generated from the plurality of audio sources may be simultaneously output through audio ducking (see 656 of FIG. 6). Audio ducking is an audio processing scheme, which allows only one audio signal from among a plurality of audio signals generated from different audio sources to be output through the speaker 264 during overlapping of the plurality of audio signals, and controls the remaining audio signals to be muted by temporarily reducing volume of the remaining audio signals such that a user is unable to listen to the audio signals.

In FIG. 6, the head unit 102 may output the audio signal of the first mobile device 112 having started audio streaming at a relatively earlier time to the speaker 264. If the second mobile device 112 outputs the system/message alarm sound while the first mobile device 112 outputs the audio signal, the head unit 102 may temporarily mute the audio signal of the first mobile device 112 according to the audio ducking scheme, and may output the audio signal of the system/message alarm sound of the second mobile device 114. Thereafter, when the system/message alarm sound is completely output, the head unit 102 may increase volume of the audio signal (i.e., cancellation of audio signal muting) of the first mobile device 112 such that the resultant audio signal is output through the speaker 264 (656).

Referring to FIG. 6, although the audio signal of the first mobile device 112 is not output while the audio signal caused by the system/message alarm sound of the second mobile device 114 is output, the audio signal of the first mobile device 112 is temporarily stopped, such that seamless output of the audio signal can be maintained and at the same time the audio streams of all Bluetooth devices multi-connected to the head unit 102 can be output without omission.

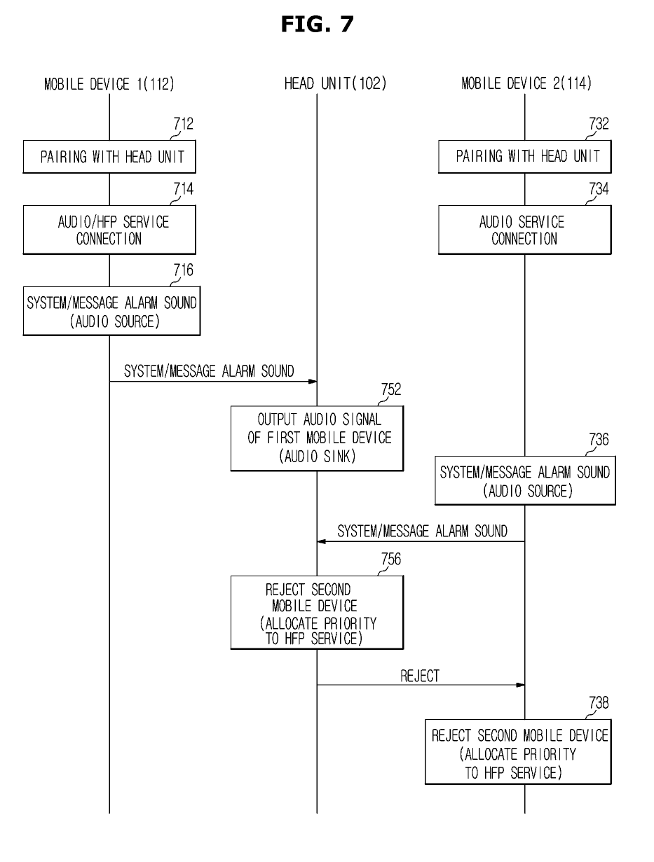

FIG. 7 is a flowchart illustrating a method for controlling multi-connection of the head unit according to a fourth embodiment of the present disclosure.

Referring to FIG. 7, the first mobile device 112 acting as a Bluetooth device may be communicably connected to the head unit 102 through Bluetooth pairing (712). Bluetooth pairing between the first mobile device 112 and the head unit 102 may require user input for authentication. Only one Bluetooth pairing between the first mobile device 112 and the head unit 102 may be considered sufficient or satisfactory. During post-pairing connection, the authentication process may be omitted, and Bluetooth connection between the first mobile device 112 and the head unit 102 may be automatically achieved.

Upon completion of Bluetooth pairing (or Bluetooth connection) between the first mobile device 112 and the head unit 102, audio/HFP (Hands-Free Profile) service connection between the first mobile device 112 and the head unit 102 may be achieved (714). The term HFP is an abbreviation of Hands-Free Profile. Due to the audio/HFP service connection, the audio stream generated by the audio function and the HFP function of the first mobile device 112 may be transmitted to the head unit 102.

In Bluetooth Low Energy (BLE) (especially versions later than 4.x), multi-connection based on Bluetooth may be supported. Other Bluetooth devices other than the first mobile device 112 may be paired with (or connected to) the head unit 102.

That is, the second mobile device 114 acting as the other Bluetooth device may be communicably connected to the head unit 102 through Bluetooth pairing (732). Bluetooth pairing between the second mobile device 114 and the head unit 102 may require user input for authentication. Only one Bluetooth pairing between the second mobile device 114 and the head unit 102 may be considered sufficient or satisfactory. During post-pairing connection, the authentication process may be omitted, and Bluetooth connection between the second mobile device 114 and the head unit 102 may be automatically achieved.

Upon completion of Bluetooth pairing (or Bluetooth connection) between the second mobile device 114 and the head unit 102, audio/HFP service connection between the second mobile device 114 and the head unit 102 may be achieved (734). Due to the audio/HFP service connection, the audio stream generated by the audio function and the HFP function of the second mobile device 114 may be transmitted to the head unit 102.

From among the mobile devices 112 and 114 connected to the head unit 102, the first mobile device 112 may first generate the system/message alarm sound (716). That is, the first mobile device 112 may operate as the audio source for generating the audio signal. For reference, when the Bluetooth device outputs the audio signal through the speaker or audio terminal, the corresponding Bluetooth device is called an audio sink. The system notification sound may include a disaster alarm sound or a low-battery alarm sound, etc. The message alarm sound may include a message (including a messenger) reception alarm sound, etc.

The head unit 102 may receive an audio stream generated through A2DP streaming in the first mobile device 112 operating as the audio source, and may output the received audio streaming through the speaker 264 (752). The head unit 102 may be an audio sink capable of outputting the audio signal.

While the audio stream of the system/message alarm sound of the first mobile device 112 is output to the speaker 264 through the head unit 102, the second mobile device 114 corresponding to the other Bluetooth device connected to the head unit 102 may generate the system/message alarm sound (736). In this case, the second mobile device 114 may be the audio source for generating the audio signal in the same manner as in the first mobile device 112. The system notification sound may include a disaster alarm sound or a low-battery alarm sound, etc. The message alarm sound may include a message (including a messenger) reception alarm sound, etc.

Due to technical limitations of BLE (especially versions later than 4.x), it is impossible to simultaneously output the audio signals generated from two audio sources. That is, whereas the head unit 102 may output only the audio signal generated from only one audio source through the speaker 264, the head unit 102 is unable to output other audio signals generated from the remaining audio sources through the speaker 264.

Therefore, the head unit 102 according to the embodiment of the present disclosure may select any one of the highest-priority audio sources from among a plurality of audio sources being multi-connected through Bluetooth communication, and may control an audio route in a manner that the audio signal of the corresponding audio source can be output through the speaker 264. The head unit 102 may reject audio signals of the remaining low-priority audio sources so as to prevent the audio signals from being output through the speaker 264, and may control the audio route in a manner that the corresponding audio to be used as an audio sink can autonomously output the audio signals.

In FIG. 7, the head unit 102 may allocate the highest priority to the first mobile device 112 connected through the HFP service. Therefore, the head unit 102 may output the audio signal of the system/message alarm sound generated by the highest-priority mobile device 112 to the speaker 264. The controller 280 may reject an audio streaming request of the second mobile device 114, that is not connected through the HFP service and has relatively low priority due to later system/message alarm sound, and may control the audio route in a manner that the audio signal of the system/message alarm sound can be autonomously generated through the speaker or audio terminal of the second mobile device 114 (756).

By the above-mentioned rejection and audio route control (756) of the head unit 102, the second mobile device 114 may be shifted from the audio source to the audio sink, and the audio signal of the system/message alarm sound generated from the second mobile device 114 may be autonomously output through the second mobile device 114 (738).

By the above-mentioned audio route control of the head unit 102, it can be recognized that the audio streams of all Bluetooth devices multi-connected to the head unit 102 can be output without omission.

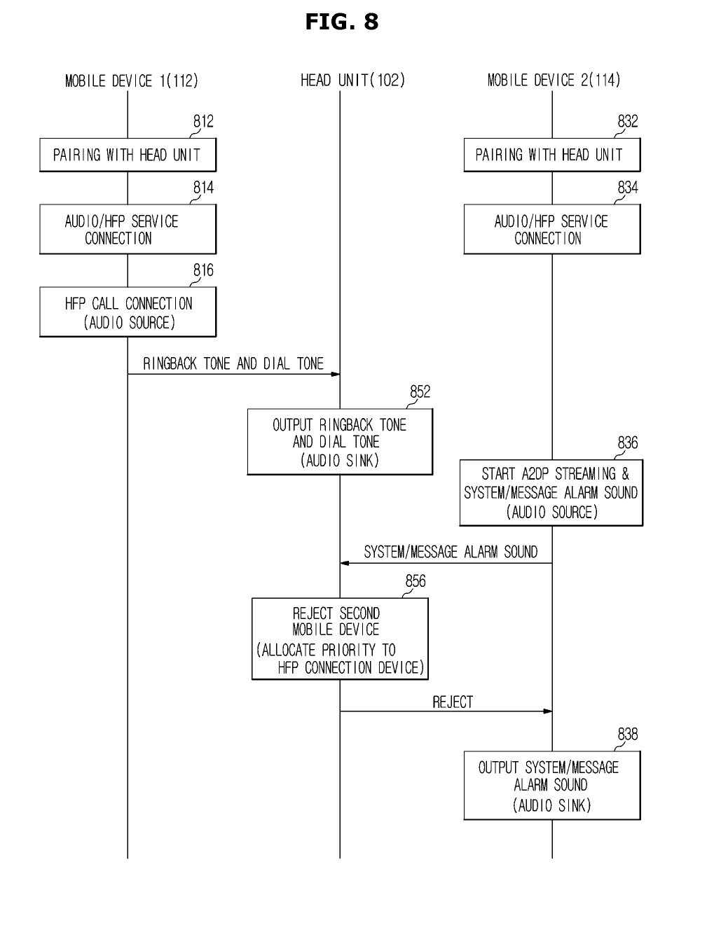

FIG. 8 is a flowchart illustrating a method for controlling multi-connection of the head unit according to a fifth embodiment of the present disclosure.

Referring to FIG. 8, the first mobile device (Mobile Device 1) 112 acting as a Bluetooth device may be communicably connected to the head unit 102 through Bluetooth pairing (612). Bluetooth pairing between the first mobile device 112 and the head unit 102 may require user input for authentication. Only one Bluetooth pairing between the first mobile device 112 and the head unit 102 may be considered sufficient or satisfactory. During post-pairing connection, the authentication process may be omitted, and Bluetooth connection between the first mobile device 112 and the head unit 102 may be automatically achieved.

Upon completion of Bluetooth pairing (or Bluetooth connection) between the first mobile device 112 and the head unit 102, audio/HFP (Hands-Free Profile) service connection between the first mobile device 112 and the head unit 102 may be achieved (814). The term HFP is an abbreviation of Hands-Free Profile. Due to the audio/HFP service connection, the audio stream generated by the audio function and the HFP function of the first mobile device 112 may be transmitted to the head unit 102.

In Bluetooth Low Energy (BLE) (especially versions later than 4.x), multi-connection based on Bluetooth may be supported. Other Bluetooth devices other than the first mobile device 112 may be paired with (or connected to) the head unit 102.

That is, the second mobile device 114 acting as the other Bluetooth device may be communicably connected to the head unit 102 through Bluetooth pairing (832). Bluetooth pairing between the second mobile device 114 and the head unit 102 may require user input for authentication. Only one Bluetooth pairing between the second mobile device 114 and the head unit 102 may be considered sufficient or satisfactory. During post-pairing connection, the authentication process may be omitted, and Bluetooth connection between the second mobile device 114 and the head unit 102 may be automatically achieved.

Upon completion of Bluetooth pairing (or Bluetooth connection) between the second mobile device 114 and the head unit 102, audio/HFP service connection between the second mobile device 114 and the head unit 102 may be achieved (834). The term HFP is an abbreviation of Hands-Free Profile. Due to the audio/HFP service connection, the audio stream generated by the audio function and the HFP function of the second mobile device 114 may be transmitted to the head unit 102.

When call connection of the first mobile device 112 occurs on the condition that the audio/HFP service connection between the first mobile device 112 and the head unit 102 is achieved, the first mobile device 112 may transmit a ringback tone and a dial tone to the head unit 102 (816). That is, the first mobile device 112 may operate as the audio source for generating the audio signal. For reference, when the Bluetooth device outputs the audio signal through the speaker or audio terminal, the corresponding Bluetooth device is called an audio sink.

The head unit 102 may receive a ringback tone and dial tone generated by the first mobile device 112 operating as the audio source, and may output the received audio stream through the speaker 264 (852). In this case, the head unit 102 may be an audio sink capable of outputting the audio signal.

While the audio stream of the first mobile device 112 is output to the speaker 264 through the head unit 102, the second mobile device 114 corresponding to the other Bluetooth device connected to the head unit 102 may generate the audio stream of the system/message alarm sound through A2DP streaming (836). In this case, the second mobile device 114 may be the audio source for generating the audio signal in the same manner as in the first mobile device 112.

Due to technical limitations of BLE (especially versions later than 4.x), it is impossible to simultaneously output the audio signals generated from two audio sources. That is, whereas the head unit 102 may output only the audio signal generated from only one audio source through the speaker 264, the head unit 102 is unable to output other audio signals generated from the remaining audio sources through the speaker 264.

Therefore, the head unit 102 according to the embodiment of the present disclosure may select any one of the highest-priority audio sources from among a plurality of audio sources being multi-connected through Bluetooth communication, and may control an audio route in a manner that the audio signal of the corresponding audio source can be output through the speaker 264. The head unit 102 may reject audio signals of the remaining low-priority audio sources so as to prevent the audio signals from being output through the speaker 264, and may control the audio route in a manner that the corresponding audio to be used as an audio sink can autonomously output the audio signals.

In FIG. 8, the head unit 102 may allocate the highest priority to the first mobile device 112 connected through the HFP service. Therefore, the head unit 102 may output the audio signals of the ringback tone and dial tone of the highest-priority mobile device 112 to the speaker 264. The head unit 102 may reject an audio streaming request of the second mobile device 114 having relatively low priority, and may control the audio route in a manner that the audio signal can be autonomously generated through the speaker or audio terminal of the second mobile device 114 (856).

By the above-mentioned rejection and audio route control (856) of the head unit 102, the second mobile device 114 may be shifted from the audio source to the audio sink, and the audio signal of the system/message alarm sound generated from the second mobile device 114 may be autonomously output through the second mobile device 114 (838).

By the above-mentioned audio route control of the head unit 102, it can be recognized that the audio streams of all Bluetooth devices multi-connected to the head unit 102 can be output without omission.

As is apparent from the above description, the embodiments of the present disclosure may output the audio streams generated from a plurality of devices connected to a single head unit through Bluetooth communication.

Although a few embodiments of the present disclosure have been shown and described, it would be appreciated by those skilled in the art that changes may be made in these embodiments without departing from the principles and spirit of the invention, the scope of which is defined in the claims and their equivalents.

What is claimed is:

1. A head unit of a vehicle, comprising:
a Bluetooth communicator configured to be communicably connected to a plurality of Bluetooth devices; and
a controller configured to allocate priority information based on a preset reference to the respective Bluetooth devices, and to control an audio route of each of the plurality of Bluetooth devices according to the priority information so as to output all audio streams generated by the plurality of Bluetooth devices.

2. The head unit according to claim 1, wherein the controller is configured to:
control the audio route in a manner that audio stream of a Bluetooth device having high priority is output through the head unit; and
control the audio route in a manner that audio stream of a Bluetooth device having low priority is output through a low-priority Bluetooth device.

3. The head unit according to claim 1, wherein the controller allocates higher priority to a Bluetooth device capable of generating an audio stream at a relatively earlier time.

4. The head unit according to claim 1, wherein the controller allocates higher priority to a Bluetooth device connected through a call-associated profile.

5. The head unit according to claim 4, wherein the call-associated profile is a hands-free profile.

6. The head unit according to claim 1, wherein the controller, when any one of the plurality of audio streams is output through audio ducking during overlapping of the plurality of audio streams generated by the plurality of Bluetooth devices, is configured to perform muting of another audio stream.

7. The head unit according to claim 6, wherein, during the audio ducking, the controller is configured to control a volume of system/message alarm sound to remain unchanged, and to perform muting of other audio streams.

8. The head unit according to claim 1, wherein, when the plurality of Bluetooth devices are interconnected through a call-associated profile, the controller is configured to allocate higher priority to a Bluetooth device staying in a call connection state through the call-associated profile.

9. The head unit according to claim 8, wherein the call-associated profile is a hands-free profile.

10. A method for controlling a head unit of a vehicle, the method comprising:
allocating priority information based on a preset reference to a plurality of Bluetooth devices interconnected to communicate with each other; and
controlling audio routes of the respective Bluetooth devices according to the priority information so as to output all audio streams generated by the plurality of Bluetooth devices.

11. The method according to claim 10, wherein controlling the audio routes includes:
controlling the audio routes in a manner that an audio stream of a Bluetooth device having high priority information is output through the head unit; and
controlling the audio routes in a manner that an audio stream of a Bluetooth having low priority information is output through a low-priority Bluetooth device.

12. The method according to claim 10, further comprising allocating a higher priority to a Bluetooth device capable of generating an audio stream at a relatively earlier time.

13. The method according to claim 10, further comprising allocating higher priority to a Bluetooth device connected through a call-associated profile.

14. The method according to claim 13, wherein the call-associated profile is a hands-free profile.

15. The method according to claim 10, further comprising, when any one of the plurality of audio streams is output through audio ducking during overlapping of the plurality of audio streams generated by the plurality of Bluetooth devices, muting another audio stream.

16. The method according to claim 15, further comprising, during the audio ducking, controlling a volume of system/message alarm sound to remain unchanged and muting other audio streams.

17. The method according to claim 10, further comprising, when the plurality of Bluetooth devices are interconnected through a call-associated profile, allocating higher priority to a Bluetooth device staying in a call connection state through the call-associated profile.

18. The method according to claim 17, wherein the call-associated profile is a hands-free profile.

19. A head unit of a vehicle, comprising:
a Bluetooth communicator configured to be communicably connected to a plurality of Bluetooth devices; and
a controller configured to allocate priority information based on a preset reference to the respective Bluetooth devices, to control an audio route in a manner that an audio stream of the Bluetooth device having high priority information is output through the head unit, and to control an audio route in a manner that an audio stream of the Bluetooth having low priority information is output through the Bluetooth device, thereby outputting all audio streams generated by the plurality of Bluetooth devices.

20. A method for controlling a head unit of a vehicle, the method comprising:
allocating priority information based on a preset reference to a plurality of Bluetooth devices interconnected to communicate with each other;
controlling an audio route in a manner that an audio stream of the Bluetooth device having high priority information is output through the head unit;
controlling an audio route in a manner that an audio stream of the Bluetooth having low priority information is output through the Bluetooth device; and
outputting all audio streams generated by the plurality of Bluetooth devices.
